(19) United States
(12) Patent Application Publication
(10) Pub. No.: US 2023/0206547 A1
(43) Pub. Date: Jun. 29, 2023

(54) METHODS AND SYSTEMS FOR INTERACTIVELY DEPICTING UNDERWATER ACTIVITY IN MULTIPLE DIMENSIONS

(71) Applicant: Global Broadband Solutions, LLC, Leesburg, VA (US)

(72) Inventors: James Case, Durham, NH (US); Nicholas Koopalethes, Leesburg, VA (US); Donald B. Yowell, Leesburg, VA (US); R. Bruce Morris, Riverside, RI (US); Kathryn Costa, Leesburg, VA (US)

(73) Assignee: Global Broadband Solutions, LLC, Leesburg, VA (US)

(21) Appl. No.: 18/087,805

(22) Filed: Dec. 22, 2022

Related U.S. Application Data
(60) Provisional application No. 63/294,266, filed on Dec. 28, 2021.

(51) Int. Cl. G06T 17/00; G06T 19/00

(52) U.S. Cl. CPC G06T 17/00; G06T 19/006

(57) ABSTRACT

Images of an environment, such as an underwater environment, may be depicted over time to allow the environment to be monitored. The images may be real-time images and may be incorporated into a virtual reality environment.

### RELATED APPLICATION

The present application is related to U.S. Provisional Application No. 63/294,266 filed Dec. 28, 2021 (the “'266 Application”). The present application claims priority to the '266 Application and incorporates by reference the entire disclosure of the '266 Application as if it were set forth in full herein.

### INTRODUCTION

This section introduces aspects that may be helpful to facilitate a better understanding of the described invention(s). Accordingly, the statements in this section are to be read in this light and are not to be understood as admissions about what is, or what is not, in the prior art.

Depicting an underwater environment and the movement and status of individuals, aquatic species and objects while underwater, such as individuals involved in the design, installation, monitoring and repair of underwater telecommunications systems (e.g., cables), is time-consuming and difficult.

The present disclosure provides methods and systems that help overcome the disadvantages of existing techniques for depicting underwater environments and the movement and status of individuals, aquatic species and objects while underwater as well as the interaction between elements under the water's surface as they interact with environmental elements outside of the water (e.g. wind, rain, snow, ice, air pressure).

While this disclosure depicts methods and systems applied to underwater environments, the invention may also be used to depict other environments, including land-based and space-based environments.

### SUMMARY

It is desirable to provide methods and systems for depicting underwater environments and the movement and status of individuals, aquatic species and objects while underwater as well as the interaction between elements under the water's surface as they interact with environmental elements outside of the water.

One such exemplary method for depicting a multi-dimensional, underwater environment may comprise: electronically integrating collected data and metadata representing one or more images of the multi-dimensional, underwater environment; receiving the integrated data and metadata and generating one or more image compositions of the underwater environment over a time period; generating modified image information of the multi-dimensional underwater environment; and transforming the one or more images and the one or more image compositions into interactive visual depictions and generating augmented, visual depictions of the multi-dimensional underwater environment.

The one or more images of the multi-dimensional, underwater environments may comprise one or more 3D images, while the one or more image compositions comprise 4D image compositions.

Such a method may further comprise generating the modified image information using electronic representations of previously generated images and refining the one or more images and one or more image compositions. To the extent augmented, visual depictions of the multi-dimensional underwater environment are generated, such augmented depictions may comprise interactive, virtual reality (VR) depictions or interactive, augmented reality (AR) depictions.

In addition to exemplary methods, the inventors also provide exemplary systems for depicting a multi-dimensional, underwater environment. One such system may comprise: an electronic, environment module operable to electronically integrate collected data and metadata representing one or more images of the multi-dimensional, underwater environment; an electronic, spatiotemporal reconstruction module operable to receive the integrated data and metadata and generate one or more image compositions of the underwater environment over a time period; an electronic, multi-dimensional spatiotemporal decision module operable to generate modified image information of the multi-dimensional underwater environment; and an electronic, image augmentation and analysis module operable to transform the one or more images and the one or more image compositions to generate augmented, visual depictions of the multi-dimensional underwater environment.

As before, the one or more images of the multi-dimensional, underwater environment may comprise one or more 3D images, while the one or more image compositions comprise 4D image compositions.

The above-mentioned electronic, multi-dimensional spatiotemporal decision module may be further operable to generate the modified image information using electronic representations of previously generated images to refine the one or more images and the one or more image compositions and the augmented, visual depictions of the multi-dimensional underwater environment (to the extent generated) may comprise interactive, VR depictions or AR depictions.

As mentioned herein, the inventive methods and systems may not be limited to underwater environments. Accordingly, one such additional exemplary method may comprise: electronically integrating collected data and metadata representing one or more images of the multi-dimensional environment; receiving the integrated data and metadata and generating one or more image compositions of the environment over a time period; generating modified image information of the multi-dimensional environment; and transforming the one or more images and the one or more image compositions into interactive visual depictions and generating augmented, visual depictions of the multi-dimensional environment.

Once again, the one or more images of the multi-dimensional environment may comprise one or more 3D images and the one or more image compositions comprise 4D image compositions.

Similar to above, such a method may yet further comprise generating the modified image information using electronic representations of previously generated images and refining the one or more images and one or more image compositions, and (to the extent generated) the augmented, visual depictions of the multi-dimensional environment comprise interactive, virtual reality (VR) depictions or interactive, augmented reality (AR) depictions.

### BRIEF DESCRIPTION OF THE DRAWINGS

FIG. 1 depicts an exemplary block diagram of a method and/or system for interactively displaying environments, such as an underwater environment, and the movement and status of individuals, aquatic species and objects underwater in multiple dimensions (e.g., 3D and/or 4D) such as, but not limited to, individuals involved in the installation, monitoring and repair of underwater telecommunications systems.

FIGS. 2A to 2H depict exemplary images of environments that may be displayed by inventive systems and methods disclosed herein.

As used herein the term “3D” means at least representing an environment (e.g., underwater environment) and the movement and status of individuals, land and water-based species (e.g., aquatic species) and objects on a display in three dimensions by providing the height, width and depth of such an environment, movement, and status while “4D” means at least representing environments, movements and statuses on a display in four dimensions by providing the height, width, depth and time (e.g., changes over time) of such an environment, movement, and status.

### DETAILED DESCRIPTION

Exemplary embodiments of methods and systems for depicting environments and the movement and status of individuals, species and objects in multiple dimensions are described herein and are shown by way of example in the drawings. Throughout the following description and drawings, like reference numbers/characters refer to like elements.

It should be understood that, although specific embodiments are discussed herein, the scope of the disclosure is not limited to such embodiments. To the contrary, it should be understood that the embodiments discussed herein are for illustrative purposes, and that modified, alternative and/or equivalent embodiments that otherwise fall within the scope of the disclosure are contemplated.

It should also be noted that one or more exemplary embodiments may be described as a process or method (the word “method” may be used interchangeably with the word “process” herein). Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method if, for example, such steps are known by those skilled in the art.

It should be understood that when a component, element or step in a method or system is referred to, or shown in a figure, as being “connected” to (or other tenses of connected) another component, element or step such components, elements or steps may be directly connected, or may use intervening components, elements or steps to aid a connection. In the latter case, if the intervening components, elements or steps are well known to those in the art they may not be described herein or shown in the accompanying figures.

As used herein the phrase “operable to” means “programmed to”, “functions to” or “configured to” electronically complete one or more specific features of a function or steps in a process, for example, by executing stored electronic instructions, for example.

As used herein the term “metadata” means at least information that relates to collected and/or stored data that can be used to identify, specify or distinguish such corresponding data (e.g., time-based metadata; temperature, pressure data; data quality; data restrictions) in order to assist a user or a system to identify the nature, features and uses of the collected and/or stored data. As used herein, metadata may or may not be displayed, though its corresponding data may be displayed.

As used herein the phrase “multi-dimensional”, “multiple dimensions” or similar phrases means at least 4D or 3D dimensions and may mean both 3D and 4D dimensions.

When reference is made to an “environment” herein, it should be understood that an underwater environment is only one of many types of environments that may be displayed by the inventive systems and methods. Other environments are land-based and space-based environments, for example. To indicate this, the word “underwater” is sometimes placed in parenthesis herein.

As used herein the phrase “real-time” means a feature of a function and/or step in a process that is completed within a specified time (i.e., a deadline), typically a relatively short time measured in seconds or minutes. For example a transmission may be completed in seconds or less, or the display of data or information may be completed in seconds or less. Thus, a real-time feature or step is generally one that happens in a defined time period having a maximum duration in order to quickly provide information about an environment from which the information was derived or is related to.

When used herein the words “module”, “engine” and “platform” mean an electronic device or circuitry that may include at least one electronic processor and at least one electronic memory operable to store specialized electronic signals constituting “instructions” that when executed by the processor cause the module, engine or platform or an associated system, subsystem, device or method that the module, engine or platform is a part of to complete one or more specific features of a function or steps in a process.

As used herein the word “integrate” means import, overlay, merge, colorize, drape, skin, and/or insert.

As used herein the phrase “image composition” or “4D image composition” means a plurality of 3D images combined into a composition of images over a time period.

As used herein, the terms “embodiment” or “exemplary” mean an example that falls within the scope of the disclosure.

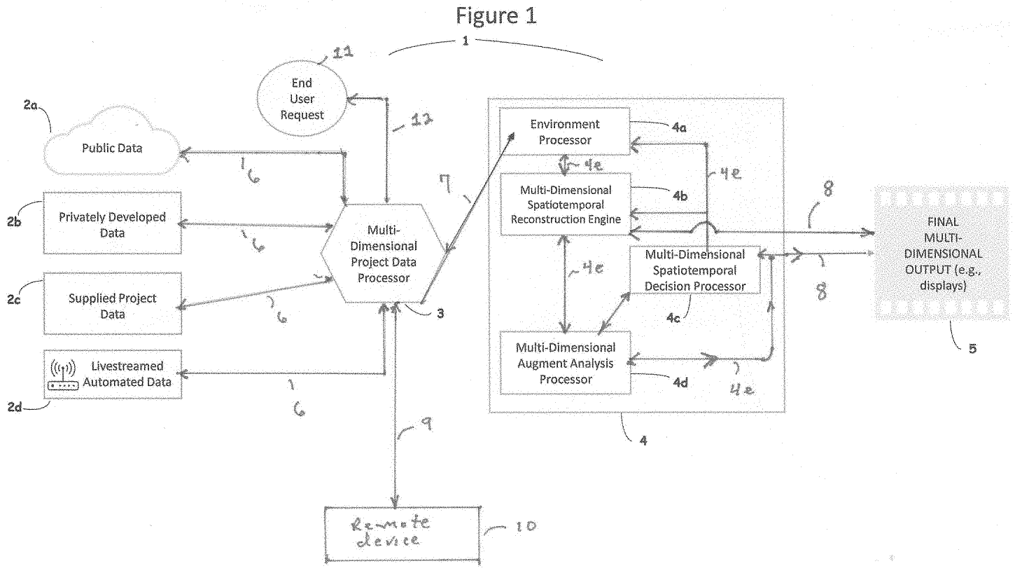

FIG. 1 illustrates an exemplary block diagram of an inventive method and/or system 1 for interactively depicting images of an underwater environment and/or images of the movement and status of individuals, aquatic species and objects underwater in multiple dimensions, such as in three for four dimensions. In one embodiment, such individuals may be involved in the installation, monitoring and repair of underwater telecommunications networks (e.g., repairing or installing an underwater cable).

As shown, an electronic, multi-dimensional processing and storage module 3 may be operable to receive image and/or image-related metadata and/or data (collectively referred to herein as “image metadata and/or data” or “image data and metadata”) in a number of different, diverse forms related to an underwater environment and/or the movement and status of individuals, aquatic species and objects underwater (e.g., marine survey, raw data) from a number of different sources 2a to 2d by executing special instructions (i.e., data migration routines) stored in a memory (not shown).

Examples of such image metadata and data may include: metadata and data from publicly available web application programming interfaces (API) endpoints or physical media 2a (without restrictions to its usage); privately developed metadata and/or data from private sources 2b (e.g., generated based on expert research and development, which may or may or not be proprietary); project metadata and/or data (e.g., project-specific or purpose-specific data, which, again, may or may or not be proprietary) from a project source 2c; and/or automated, livestreamed metadata and/or data collected, for example, from outside sources 2d. All of the exemplary, diverse image metadata and data may be transmitted to module 3 in real-time via wired or wireless electronic or optical communication links or pathways 6.

In more detail, numerous public and private sources containing diverse image metadata and/or data as well as other types of metadata and data related to an underwater environment and/or the movement and status of individuals, aquatic species and objects underwater may first be acquired, then cataloged, versioned, and/or reviewed for quality control and then stored (e.g., archived) by module 3. In an embodiment, the diverse, image metadata and/or data from sources 2a to 2d (e.g., from storage devices that store such metadata and/or data) may be received by, and input into, the electronic, multi-dimensional image processing and storage module 3 via links or pathways 6.

In embodiments, image metadata and/or data as well as other types of metadata and data from sources 2a to 2d may take the form of scanned documents, reports, and the like in database transferrable formats, GIS formats, etc. . . . .

As part of a cataloging or versioning function or process the module 3 may, or may not, reformat some of the received, diverse image metadata and/or data into a selected format for further processing. For example, module 3 may be operable to store specialized electronic instructions that function to process marine survey, raw metadata and/or data that may be part of the image metadata and data received from sources 2a to 2d and, if need be, reformat the image metadata and/or data for later usage. One example of such instructions may take the form of a global mapping process or program.

In embodiments, either module 3 or sources 2a to 2d may be further operable to organize image metadata and data as electronic fields that represent descriptors or annotators associated with each piece of corresponding data, for example, in order to further organize the metadata that describes the state of images and data. The descriptors or annotators may represent data restrictions, data quality and intended usage, for example.

Yet further, module 3 may be operable to receive livestreamed metadata and its corresponding data as part of an automated processing feature. For example, source 2d may automatically transmit livestreamed metadata and data to module 3 (e.g., metadata and data from a weather buoy that is livestreaming weather information) without first receiving an electronic instruction (signal) from module 3 (i.e., the instruction is received “automatically”). Upon receiving such livestreamed metadata and data, the module 3 may be operable to provide such livestreamed metadata and data to subsystem 4 in order to eventually generate and send instructions (e.g., electronic signals) to one or more display devices or display modules 5 (hereafter collectively referred to as “display”) to adjust previously received, similar data being displayed (or available to display) in real time. The adjustment of the data may reflect changes in the data in real time based on a comparison of previously received metadata and data to currently received metadata and data by subsystem 4, for example.

The module 3 may be further operable to execute electronic instructions stored in its memory to, for example, simultaneously catalog and search/query the received. collected image metadata and corresponding data, among other types of collected metadata and data, from sources 2a to 2d by, for example, comparing the received image metadata and/or data to search terms (e.g., annotations and geospatial values) in order to identify and properly convert data that matches, or is associated with a matching search term into a format that can eventually be used to create a multi-dimensional, 3D or 4D, displayed environment. The received and collected metadata and data may be stored in a spatially-aware database (not shown in figures), for example.

In an embodiment, subsystem 4 may then receive and/or retrieve the collected image data and metadata as well as other types of metadata and data from module 3 to generate a multi-dimensional (e.g., 3D and/or 4D) underwater environment (e.g., a 3D or 4D image or composition of images depicting an underwater environment), among other things.

Subsystem 4 may comprise an electronic, environment module 4a (e.g., one or more electronic processors) that may be operable to electronically integrate the collected data and metadata received from module 3 with stored data representing an image (or images) of a multi-dimensional, underwater environment for example, so that images and/or image compositions of a multi-dimensional underwater environment or images and/or image compositions of a virtual multi-dimensional underwater environment may be generated by other elements of the subsystem 4.

In an embodiment, the integration functions and/or processes completed by module 4a may include generating a plurality of sets of length, width and height data and metadata, each set at a particular moment in time from the collected data. Though time metadata and data may be included in each integrated data set, it is only a “snap shot” of one moment in time and, thus, each set of integrated metadata and data—processed individually—represents an image of a 3D environment.

Subsystem 4 may also comprise an electronic, spatiotemporal reconstruction module or “engine”, 4b (i.e., electronic processor that executes, stored specialized electronic instructions). Module 4b may be operable to receive the integrated sets of length, width, height and time data and metadata from module 4a and then generate a composition of 3D images of an underwater environment over a time period, for example (i.e., a 4D image composition) by combining the individual 3D images into an image composition that depicts how a multi-dimensional environment may change over a time period.

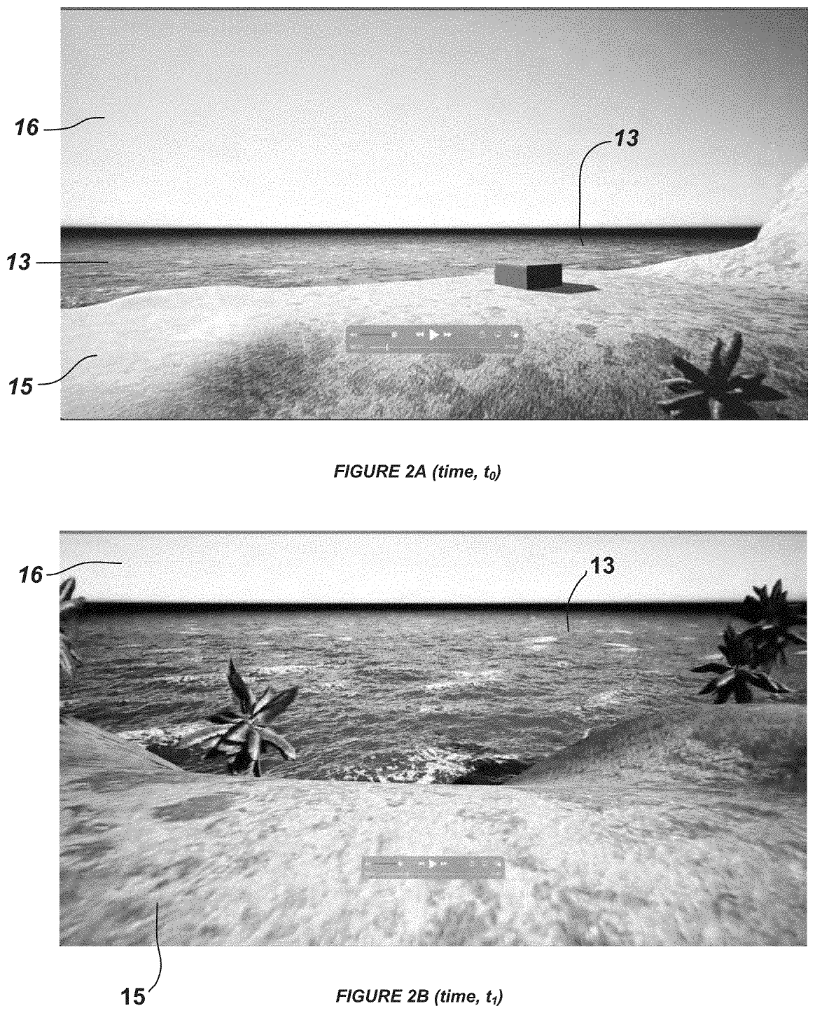

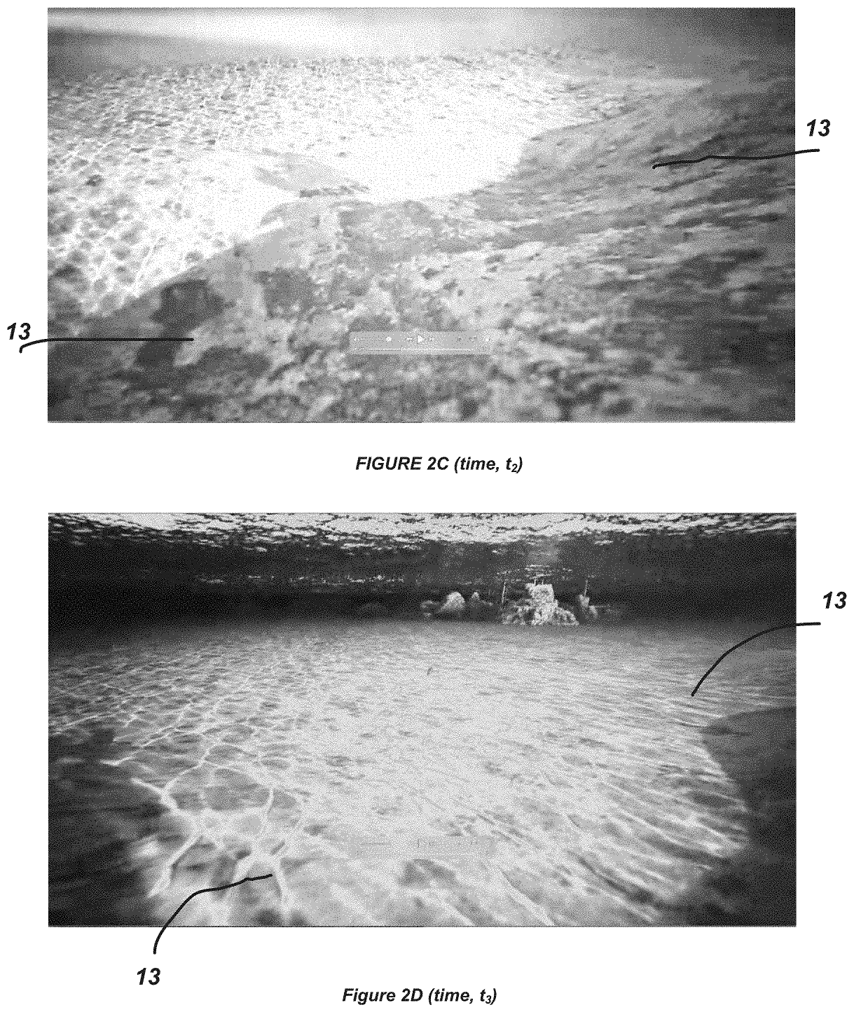

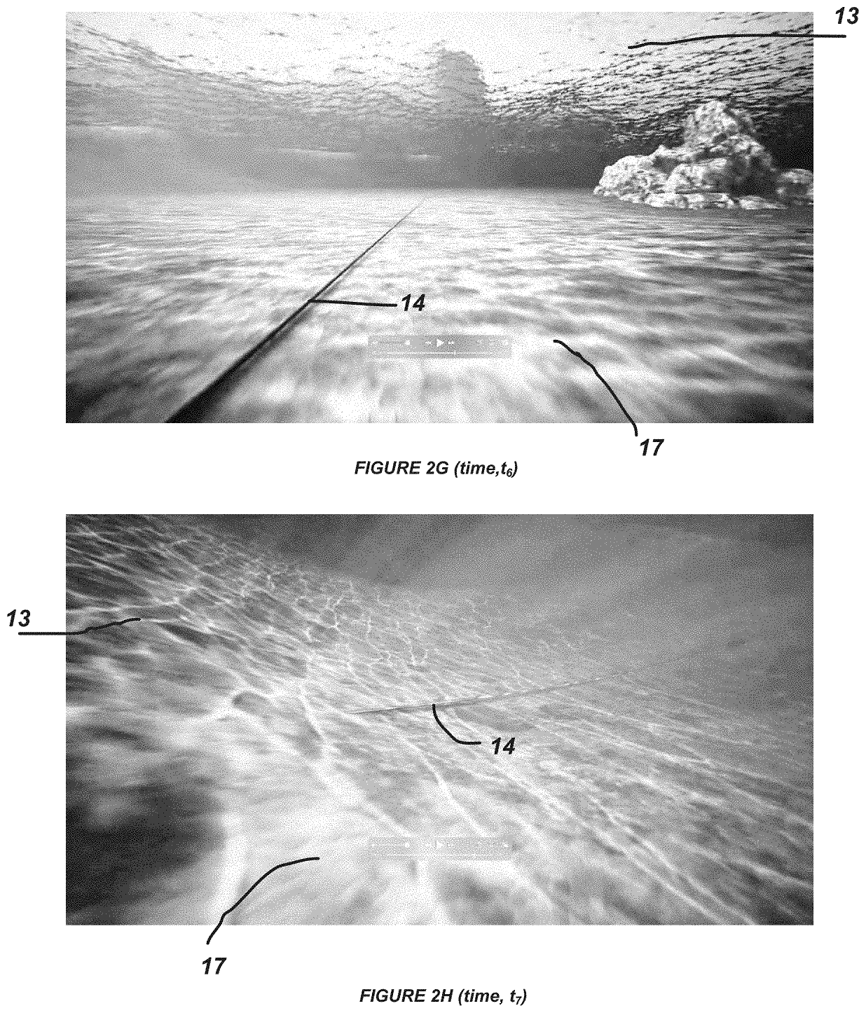

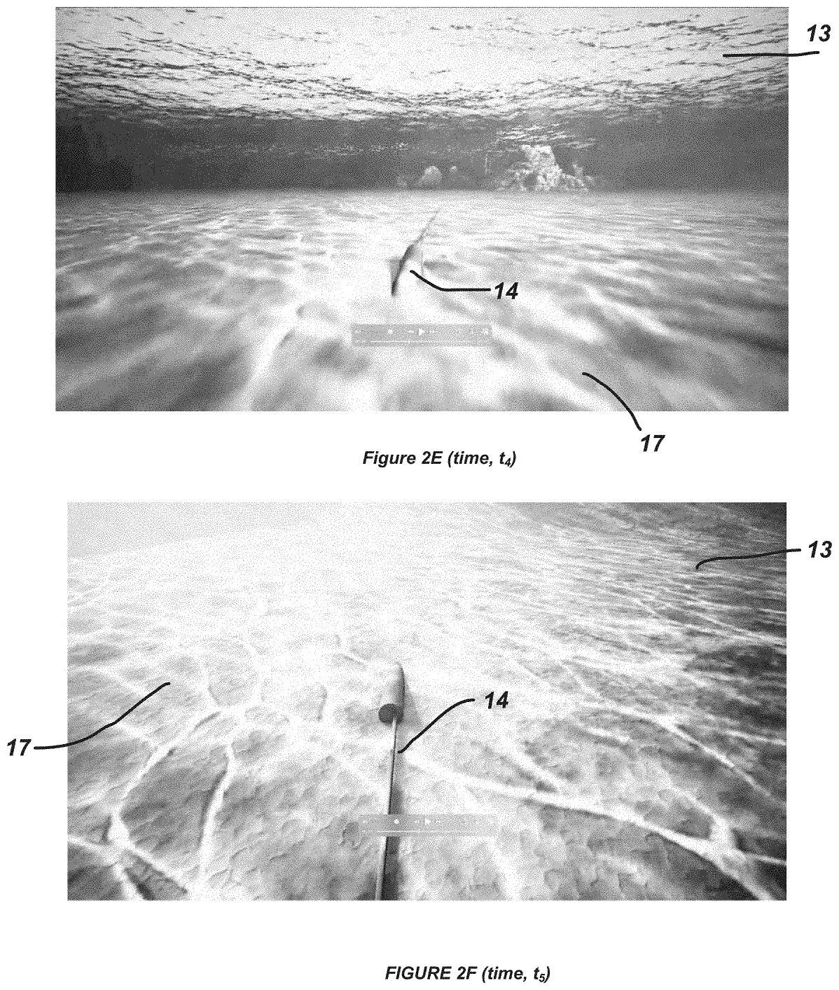

The 4D composition of images may comprise a series of images comprising a “time lapse” depicting or representing events and their environments in a time progression series, or a past event based on historical metadata, or a future event based on predictive metadata and artificial intelligence (AI) processes, or a series of future events in a continuum. FIGS. 2A to 2H illustrate an exemplary 4D composition of 3D images of an underwater environment over a time period t₀ to t₇, where each 3D image in the composition of images represents the environment at specific time t₀ to t₇.

In the exemplary embodiments depicted in FIGS. 2A to 2H, the composition of images depicts various scenes of land 15 and air 16, scenes above the water 13 as well as scenes of a telecommunications cable 14 under the water 13 lying on the surface of an underwater bed 17 or partially covered by the bed 17. Again, it should be understood that the type of images depicted in FIGS. 2A to 2H comprise only one of many possible image types that may be generated by the system 1.

Further, module 4b may be operable to apply color and texture to elements of an image (e.g., to the water, seabed grass, marine species, etc.,) based on collected image metadata and data or based on image metadata and data stored in a memory of module 4b (not shown in FIG. 1).

Hereafter the images or composition of images generated by module 4b may be referred to as “image information”. When such image information is initially received by module 4c from module 4b, it may be referred to as “original image information”.

Continuing, subsystem 4 may further comprise an electronic, multi-dimensional spatiotemporal decision module 4c that may be operable to receive image information from module 4b and modify the image information by, for example, completing so called artificial intelligence (AI) processes, where the received image information may function as inputs into an exemplary AI process.

In more detail, module 4c may be operable to execute stored instructions representing one or more AI processes to update or “train” the module 4c to generate modified image information of an environment over time using, for example, electronic representations of previously generated images to further refine future images and image compositions of a multi-dimensional, underwater environment.

For example, in one embodiment module 4c may be operable to electronically alter the image information it receives from (i) module 4b based on stored instructions, (ii) instructions it receives from a user device 11 or from (iii) electrical signals (i.e., modifications) made by module 4d as described elsewhere herein. Thereafter, the altered or modified (hereafter “modified”) image information may be sent back to module 4b to allow module 4b to generate modified 3D images that may comprise modified 4D image compositions.

Still further, in an embodiment module 4c may be operable to control the generation of multiple versions of 4D images of an environment. For example, depending on pre-determined, stored electronic instructions in its memory or based on electronic instructions received from a user device 11 via telecommunications channel 12 or electrical signals from module 4d via internal bus 4e, module 4c may request additional image information from module 4b that may include individual images or an image composition that represent a shorter or longer time period when compared to the time period associated with original image information, to name just one example. Further, module 4c may alter the position in time of a particular image or images to refine how the metadata and data are used to generate different visual images and image compositions.

More particularly in one embodiment, a user operating user device 11 may wish to track the position and status of the cable 14 depicted in FIGS. 2E to 2H over a longer time period than the time period represented by time period t₄ to t₇ in FIGS. 2E to 2H order to, for example, view the physical integrity of the cable 14 and/or view any object or species that may potentially damage the cable 14 as a part of a service that maintains and/or monitors the operation of the cable (e.g., guarantees telecommunication signals being carried by the cable 14 can be transferred successfully).

Accordingly, upon receiving instructions from the user 11 or by retrieving instructions from its memory (not shown in FIG. 1) or upon receiving signals from module 4d, module 4c may be operable to request additional image information from module 4b, for example. Upon receiving the additional information, module 4c may be operable to electronically generate revised images or image compositions of an environment based on the additional image information it receives from module 4b by, for example, combining the individual images making up the additional image information into a revised or modified composition that depicts how a multi-dimensional environment may change over a time period that differs from t₄ to t₇.

Thereafter, the module 4c may be operable to request yet further additional image information from module 4b in accordance with user or stored instructions or additional signals from module 4d if need be.

Similarly, rather than request image information from module 4b, module 4c may request additional, raw metadata and data from module 4a in order to generate revised or modified 3D images and/or 4D image compositions of an environment.

In an embodiment, the capability to request additional image information and/or raw metadata and data from modules 4a and/or 4b functions to give the module 4c (and subsystem 4) the ability to identify and correct and/or refine (hereafter collectively “refine” or its' grammatical tenses, e.g., refinement) anomalies and patterns in the metadata and/or data. This in turn provides the subsystem 4 with the capability to refine any unwanted anomaly and/or pattern from an image or composition of images.

The refinement of unwanted anomalies and/or patterns may continue until such time as the module 4c determines that the revised composition satisfies parameters of the user or stored instructions (e.g., the process continues until module 4c determines that the anomaly, correction and/or refinement is too small to make a noticeable difference in an image or composition of images).

Module 4c may be further operable to generate situational guidance (i.e., potential “next steps”) using stored instructions representing an evolving “decision tree” process. In an embodiment, upon executing such instructions module 4c may be operable to generate a set of electronic signals representing potential “next steps” and send such signals to an electronic multi-dimensional, image augmentation and analysis module 4d along with signals representing images of a multi-dimensional environment over time (underwater) environment (either an original or revised images of an environment).

In an embodiment, the module 4d may be operable to execute stored electronic instructions to transform the images and/or image compositions received from module 4c or 4b into augmented, interactive visual depictions (e.g., interactive underwater images, visuals, MP4 video, platform-independent images/videos, VR images, animations), for example.

In more detail, module 4d may receive instructions (e.g., electrical signals) from user device 11 either directly or via internal electrical pathways or buses 4e from modules 4a, 4b or 4c to transform a particular image or image composition of a multi-dimensional (underwater) environment the module 4d may receive from module 4b or 4c, for example.

Thereafter, module 4d may execute additional instructions to transform the images or image compositions by, for example, generating augmented, visual depictions representing an augmented, multi-dimensional (underwater) environment over time as interactive, virtual reality (VR) depictions or interactive, augmented reality (AR) depictions and then output such augmented, 4D visual depictions to display 5, for example, or send them to modules 4b or 4c for output to display 5.

It should be understood that augmentation by module 4d is optional. Thus, when no augmentation is required by module 4d then module 4b or 4c may be further operable to execute additional instructions to generate visual depictions representing images of a multi-dimensional (underwater) environment over time (e.g., 4D images) or, as needed, 3D images and then output such visual depictions to display 5.

Again, it should be understood that while the embodiments just described output visual depiction(s) of an underwater environment, such an environment is just one of many types of environments that may be generated by system 1. The depictions may be further stored for later usage in memory (not shown) or in a separate electronic storage device (e.g., a database), for example.

It should be understood that one or more of the functions and processes completed by one or more modules of the system 1, such as the functions and processes completed by module 3 and modules 4a to 4d may be “transportable”. That is to say, in an embodiment the executable, electronic instructions stored within each module 3, 4a to 4d that allow a respective module to complete its designated functions and processes may be configured to be compatible with a third party platform, such as Android, MAC, Windows or iOS. Thereafter, the so configured instructions may then be transmitted to, and stored by, a remote system 10 via communication pathway 9, for example, so that the stored instructions may be executed by the remote system 10 executing the 3rd party platform. Said another way, modules 3, 4a to 4d may exchange electronic signals with other systems executing third party platforms (Android, Mac, Windows, iOS, etc. . . . ) to exchange images of multi-dimensional (underwater) environments over time while at the same time storing and monitoring each version of an image of a multi-dimensional (underwater) environment, for example.

Still further, remote system 10 may be operable to receive its own image metadata and/or data (other than from sources 2a to 2d, for example), execute the so compatible instructions it has received and stored in order to allow the remote system 10 to generate visual depictions representing images of a multi-dimensional (underwater) environment over time (e.g., 4D images) or, as needed, 3D images and then output such visual depictions to a separate display (not shown).

It should be understood that the disclosure provided herein describes features in terms of specific exemplary embodiments. However, numerous additional embodiments and modifications within the scope and spirit of the disclosure will occur to persons of ordinary skill in the art from a review of this disclosure and are intended to be covered by the disclosure.

Accordingly, this disclosure includes all such additional embodiments, modifications and equivalents of the subject matter as permitted by applicable law. Moreover, any combination of the above-described components in all possible variations thereof is encompassed by the disclosure unless otherwise indicated herein or otherwise clearly contradicted by context.

We claim:

1. A method for depicting a multi-dimensional, underwater environment comprising:
electronically integrating collected data and metadata representing one or more images of the multi-dimensional, underwater environment;
receiving the integrated data and metadata and generating one or more image compositions of the underwater environment over a time period;
generating modified image information of the multi-dimensional underwater environment; and
transforming the one or more images and the one or more image compositions into interactive visual depictions and generating augmented, visual depictions of the multi-dimensional underwater environment.

2. The method as in claim 1 wherein the one or more images of the multi-dimensional, underwater environment comprises one or more 3D images.

3. The method as in claim 1 wherein the one or more image compositions comprise 4D image compositions.

4. The method as in claim 1 further comprising generating the modified image information using electronic representations of previously generated images and refining the one or more images and one or more image compositions.

5. The method as in claim 1 wherein the augmented, visual depictions of the multi-dimensional underwater environment comprise interactive, virtual reality (VR) depictions or interactive, augmented reality (AR) depictions.

6. A system for depicting a multi-dimensional, underwater environment comprising:
an electronic, environment module operable to electronically integrate collected data and metadata representing one or more images of the multi-dimensional, underwater environment;
an electronic, spatiotemporal reconstruction module operable to receive the integrated data and metadata and generate one or more image compositions of the underwater environment over a time period;
an electronic, multi-dimensional spatiotemporal decision module operable to generate modified image information of the multi-dimensional underwater environment; and
an electronic, image augmentation and analysis module operable to transform the one or more images and the one or more image compositions to generate augmented, visual depictions of the multi-dimensional underwater environment.

7. The system as in claim 6 wherein the one or more images of the multi-dimensional, underwater environment comprises one or more 3D images.

8. The system as in claim 6 wherein the one or more image compositions comprise 4D image compositions.

9. The system as in claim 6 wherein the electronic, multi-dimensional spatiotemporal decision module is further operable to generate the modified image information using electronic representations of previously generated images to refine the one or more images and one or more image compositions.

10. The system as in claim 6 wherein the augmented, visual depictions of the multi-dimensional underwater environment comprise interactive, virtual reality (VR) depictions or interactive, augmented reality (AR) depictions.

11. A method for depicting a multi-dimensional environment comprising:
electronically integrating collected data and metadata representing one or more images of the multi-dimensional environment;
receiving the integrated data and metadata and generating one or more image compositions of the environment over a time period;
generating modified image information of the multi-dimensional environment; and
transforming the one or more images and the one or more image compositions into interactive visual depictions and generating augmented, visual depictions of the multi-dimensional environment.

12. The method as in claim 11 wherein the one or more images of the multi-dimensional environment comprises one or more 3D images.

13. The method as in claim 11 wherein the one or more image compositions comprise 4D image compositions.

14. The method as in claim 11 further comprising generating the modified image information using electronic representations of previously generated images and refining the one or more images and one or more image compositions.

15. The method as in claim 11 wherein the augmented, visual depictions of the multi-dimensional environment comprise interactive, virtual reality (VR) depictions or interactive, augmented reality (AR) depictions.
